(19) United States
(12) Patent Application Publication
(10) Pub. No.: US 2025/0138282 A1
(43) Pub. Date: May 1, 2025

(54) IMAGING LENS

(71) Applicant: Young Optics Inc., Hsinchu Science Park (TW)

(72) Inventor: Tsung-Pei HSIEH, Hsinchu Science Park (TW)

(21) Appl. No.: 18/794,232

(22) Filed: Aug. 5, 2024

(30) Foreign Application Priority Data
Oct. 25, 2023 (TW) 112140936

(51) Int. Cl. G02B 13/00; G02B 3/00; G02B 9/12

(52) U.S. Cl. CPC G02B 13/0035; G02B 3/0087; G02B 9/12

(57) ABSTRACT

An imaging lens includes a first lens, a second lens and a third lens arranged in order from an object side to an image side. The first lens has a negative refractive power, the imaging lens includes no more than nine lenses with refractive powers, and one of the no more than nine lenses has a gradient refractive index. An aperture stop is disposed between two outermost lenses with refractive powers at opposite ends of the imaging lens. The lens having a gradient refractive index satisfies a condition of
1<D/T<32, where D is a maximum outer diameter of the lens having a gradient refractive index, and T is a thickness of the lens having a gradient refractive index measured along an optical axis of the imaging lens.

### CROSS-REFERENCE TO RELATED APPLICATION

This application claims the priority benefit of Taiwan application serial no. 112140936, filed Oct. 25, 2023. The entirety of the above-mentioned patent application is hereby incorporated by reference herein and made a part of this specification.

### BACKGROUND

### Field of the Invention

The invention relates to an imaging lens.

### Description of the Related Art

In recent years, electronic products with imaging capabilities have been applied in various fields, such as security monitoring, vehicle camera systems, and sports cameras. In this context, an optical imaging lens that can achieve wide viewing angles, miniaturization, and high imaging quality is required. However, conventional wide-angle lenses are limited by the shape and material of the lens elements, necessitating a greater number of lens elements or varying the thickness of the optical filter to achieve chromatic aberration correction and compatibility with both infrared and visible wavelengths. Therefore, there is an urgent need for an imaging lens that concurrently satisfies wide viewing angles and chromatic aberration correction, and provides high-quality imaging for both visible and infrared light without the need to vary the thickness of the optical filter.

### BRIEF SUMMARY OF THE INVENTION

In order to achieve one or a portion of or all of the objects or other objects, one embodiment of the invention provides an imaging lens including a first lens, a second lens, and a third lens arranged in order from an object side to an image side and an aperture stop. The first lens has a negative refractive power, and one of the no more than nine lenses is a gradient-index (GRIN) lens. The aperture stop is disposed between two outermost lenses with refractive powers at opposite ends of the imaging lens. The gradient-index lens satisfies a condition of 1<D/T<32, where D is a maximum outer diameter of the gradient-index lens, and T is a thickness of the gradient-index lens measured along an optical axis of the imaging lens.

Another embodiment of the invention provides an imaging lens including a first lens, a second lens, and a third lens arranged in order from an object side to an image side and an aperture stop. The first lens has a negative refractive power, the imaging lens includes no more than nine lenses with refractive powers, and one of the no more than nine lenses is an inhomogeneous material lens. Two opposite surfaces of the inhomogeneous material lens along the optical axis of the imaging lens have different refractive indices. An aperture stop is disposed between two outermost lenses with refractive powers at opposite ends of the imaging lens. The inhomogeneous material lens satisfies a condition of 1<D/T<32, where D is a maximum outer diameter of the inhomogeneous material lens, and T is a thickness of the inhomogeneous material lens measured along an optical axis of the imaging lens.

Another embodiment of the invention provides an imaging lens including a first lens, a second lens, and a third lens arranged in order from an object side to an image side and an aperture stop. The first lens has a negative refractive power, the imaging lens includes no more than nine lenses with refractive powers, and one of the no more than nine lenses is a flat lens with a refractive power having a smooth surface without microstructures. The aperture stop is disposed between two outermost lenses with refractive powers at opposite ends of the imaging lens.

Through the design of various embodiments of the invention, by adhering to the aforementioned component characteristics and configuration conditions, the imaging lens can provide good chromatic aberration correction while meeting the wide viewing angle requirements. This is achieved without needing to change the thickness of the optical filter, allowing for high-quality imaging in both visible and infrared light. Furthermore, by appropriately combining glass and plastic lenses with spherical and aspherical surfaces, the imaging lens can withstand high temperatures and temperature fluctuations in the operating environment, thereby reducing manufacturing costs while maintaining image quality. Moreover, the imaging lens includes at least one gradient-index singlet lens/inhomogeneous-material singlet lens, which can provide chromatic aberration correction similar to that of cemented lenses. This configuration can reduce the number of cemented lenses used, thereby decreasing the lens size, number of lenses, or overall length while meeting the requirements for chromatic aberration correction and use of both infrared light and visible light imaging.

Other objectives, features and advantages of the invention will be further understood from the further technological features disclosed by the embodiments of the invention wherein there are shown and described preferred embodiments of this invention, simply by way of illustration of modes best suited to carry out the invention.

### BRIEF DESCRIPTION OF THE DRAWINGS

FIG. 1 is a schematic diagram of an imaging lens according to a first embodiment of the invention.

FIG. 2A, FIG. 2B, and FIG. 2C respectively show the longitudinal spherical aberration, field curvature aberration, and distortion aberration curves of the imaging lens of the first embodiment measured at wavelengths of 486 nm, 546 nm, and 656 nm.

FIG. 3 is a schematic diagram of an imaging lens according to a second embodiment of the invention.

FIG. 4A, FIG. 4B, and FIG. 4C respectively show the longitudinal spherical aberration, field curvature aberration, and distortion aberration curves of the imaging lens of the second embodiment measured at wavelengths of 486 nm, 546 nm, and 656 nm.

FIG. 5 is a schematic diagram of an imaging lens according to a third embodiment of the invention.

FIG. 6A, FIG. 6B, and FIG. 6C respectively show the longitudinal spherical aberration, field curvature aberration, and distortion aberration curves of the imaging lens of the third embodiment measured at wavelengths of 486 nm, 546 nm, and 656 nm.

FIG. 7 is a schematic diagram of an imaging lens according to a fourth embodiment of the invention.

FIG. 8A, FIG. 8B, and FIG. 8C respectively show the longitudinal spherical aberration, field curvature aberration, and distortion aberration curves of the imaging lens of the fourth embodiment measured at wavelengths of 486 nm, 546 nm, and 656 nm.

FIG. 9 is a schematic diagram of an imaging lens according to a fifth embodiment of the invention.

FIG. 10A, FIG. 10B, and FIG. 10C respectively show the longitudinal spherical aberration, field curvature aberration, and distortion aberration curves of the imaging lens of the fifth embodiment measured at wavelengths of 486 nm, 546 nm, and 656 nm.

FIG. 11 is a schematic diagram of an imaging lens according to a sixth embodiment of the invention.

FIG. 12A, FIG. 12B, and FIG. 12C respectively show the longitudinal spherical aberration, field curvature aberration, and distortion aberration curves of the imaging lens of the sixth embodiment measured at wavelengths of 486 nm, 546 nm, and 656 nm.

FIG. 13 is a schematic diagram of an imaging lens according to a seventh embodiment of the invention.

FIG. 14A, FIG. 14B, and FIG. 14C respectively show the longitudinal spherical aberration, field curvature aberration, and distortion aberration curves of the imaging lens of the seventh embodiment measured at wavelengths of 486 nm, 546 nm, and 656 nm.

### DETAILED DESCRIPTION OF THE INVENTION

In the following detailed description of the preferred embodiments, directional terminology, such as “top,” “bottom,” “front,” “back,” etc., is used with reference to the orientation of the Figure(s) being described. The components of the invention can be positioned in a number of different orientations. As such, the directional terminology is used for purposes of illustration and is in no way limiting. Further, “First,” “Second,” etc., as used herein, are used as labels for nouns that they precede, and do not imply any type of ordering (e.g., spatial, temporal, logical, etc.).

The term “lens” refers to an element made from a partially or entirely light-transmissive material with optical power. The material commonly includes plastic or glass.

In an imaging system, an object side may refer to one side of an optical path of an imaging lens comparatively near a subject to be picked-up, and an image side may refer to other side of the optical path comparatively near a photosensor.

A certain region of an object side surface (or an image side surface) of a lens may be convex or concave. Herein, a convex or concave region is more outwardly convex or inwardly concave in the direction of an optical axis as compared with other neighboring regions of the object/image side surface.

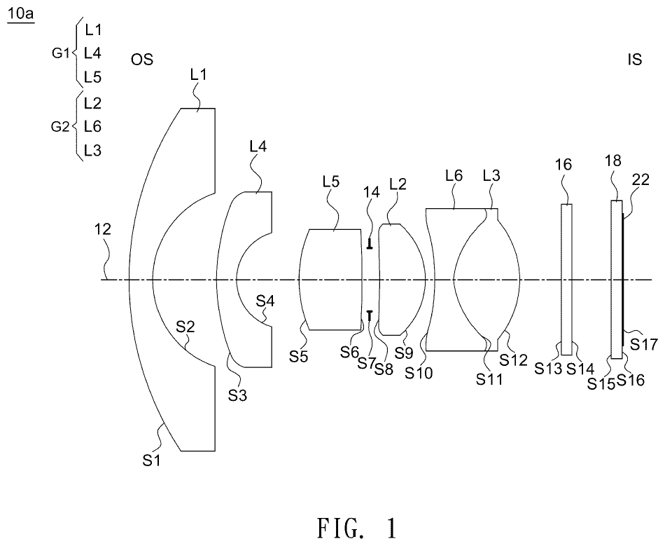

FIG. 1 is a schematic diagram of an imaging lens according to a first embodiment of the invention. Referring to FIG. 1, an imaging lens 10a includes, in order from an object side OS to an image side IS, a lens L1, a lens L4, a lens L5, a lens L2, a lens L6, and a lens L3, an optical filter 16 and a cover plate 18. In this embodiment, the lenses L1, L4, and L5 with refractive powers constitute a first lens group G1, the lenses L2, L6, and L3 with refractive powers constitute a second lens group G2, and an aperture stop 14 is disposed between the lens L5 and the lens L2. The aperture stop 14 is a light-blocking element that limits the amount of light passing through the imaging lens. In one embodiment, the aperture stop 14 is an independent optical element; in another embodiment, the aperture stop 14 is defined by an inner diameter of a lens barrel. In at least some embodiments, the aperture stop 14 can be disposed at other locations between the lens L1 and the lens L2. In this embodiment, light from a subject to be captured may enter the imaging lens 10a and pass through the lens L1, the lens L4, the lens L5, the aperture stop 14, the lens L2, the lens L6, the lens L3, the optical filter 16, and the cover plate 18 in succession and finally forms an image on the image plane 22. The object side OS faces the subject to be captured, and the image side IS faces the image plane 22. In this embodiment, the refractive power of the first lens group G1 is negative, and the refractive power of the second lens group G2 is positive. The optical filter 16, for example, is an infrared optical filter, which allows light of the desired wavelength (such as infrared and visible light) to pass through and optical filters out light of other wavelengths. The cover plate 18 can be made of any suitable light-transmitting material, such as glass, and can be used to adjust the overall length of the imaging lens and provide protection for the imaging lens.

In at least some embodiments of the invention, the imaging lens includes no more than nine lenses with refractive powers, and at least one of these lenses is a gradient-index (GRIN) lens or an inhomogeneous material lens. A gradient-index lens is an optical lens whose internal material refractive index distribution gradually changes along the radial or axial direction. An inhomogeneous material lens refers to a lens made from two or more materials with different refractive indices, causing light to refract as it travels through the lens. The gradient-index lens/inhomogeneous material lens may have different refractive indices on two opposite surfaces along the optical axis of the lens and may be a spherical lens, an aspheric lens, or a flat lens with a refractive power having a smooth surface without microstructures. Furthermore, in at least some embodiments of the invention, the specific lens having a gradient refractive index (such as a gradient-index lens, an inhomogeneous material lens, or a flat lens with a refractive power having a smooth surface without microstructures) satisfies a condition of 1<D/T<32, preferably 5<D/T<13, where D is a maximum outer diameter of the specific lens with a gradient refractive index, and T is a thickness of the specific lens with a gradient refractive index measured along the optical axis of the imaging lens (i.e., the center thickness of the lens with a gradient refractive index). Meeting the above conditions may achieve the balance between compact design and efficient aberration correction to enhance the performance and applicability of the imaging lens.

In at least some embodiments of the invention, the aperture stop 14 is disposed between two outermost lenses at opposite ends of the imaging lens. In all figures, the object side (OS) is positioned on the left, while the image side (IS) is on the right, and this will not be repeatedly described. In this embodiment, the refractive powers of the lens L1, the lens L4, the lens L5, the lens L2, the lens L6, and the lens L3 are negative, negative, positive, positive, negative, and positive, respectively. The lens L1 is a glass spherical lens, the lens L2 is a glass-molded aspheric lens, and the lens L4, the lens L5, the lens L6, and the lens L3 are plastic aspheric lenses, but this is not limiting. The lens L6 and the lens L3 are bonded together to form a compound lens, such as a cemented doublet, but this is not limiting. Bonding the lens L6 and the lens L3 can correct chromatic aberrations and tolerate higher manufacturing tolerances, thereby increasing yields. Additionally, in this embodiment, the lens with a gradient refractive index is the optical filter 16, which can be a flat lens having a refractive power and a smooth surface without microstructures, and the value of D/T of the optical filter 16 is 12.36. The above structure combining glass and plastic materials and using a gradient refractive index lens can further eliminate chromatic and spherical aberrations, thus improving image quality.

A diagonal field of view (DFOV) refers to a light collection angle of the optical surface closest to the object side; that is, the DFOV is a full field of view measured diagonally. In this embodiment, the DFOV of the imaging lens 10a is 170 degrees. Furthermore, in this embodiment, a total track length TTL of the imaging lens 10a (the length from an object-side surface S1 of the lens L1 to the image plane 22 on the optical axis 12) is 13.4 mm, and a total lens length LT is 12.02 mm, where the total lens length LT is a distance measured along the optical axis 12 between two outermost lens surfaces with refractive powers (such as the object-side surface S1 of the lens L1 and the image-side surface S12 of the lens L3 in FIG. 1) at opposite ends of the imaging lens. In this embodiment, an effective focal length EFL is 1.2 mm, an F-number (F #) is 1.8, and a maximum image height is 1.96 mm.

Detailed optical data and design parameters of the imaging lens 10a are shown in Table 1 below. Note the data provided below are not used for limiting the invention, and those skilled in the art may suitably modify parameters or settings of the following embodiment with reference of the invention without departing from the scope or spirit of the invention.

Table 1 lists the values of parameters for each lens of an imaging system. The radius of curvature and interval shown in Table 1 are all in a unit of mm. The field heading “radius of curvature” shown in Table 1 is a reciprocal of the curvature. When a lens surface has a positive radius of curvature, the center of the lens surface is located towards the image side. When a lens surface has a negative radius of curvature, the center of the lens surface is located towards the object side. The field heading “interval” represents a distance between two adjacent surfaces along the optical axis 12 of the imaging lens 10a. For example, an interval of the surface S1 is a distance between the surface S1 and the surface S2 along the optical axis 12, and an interval of the surface S2 is a distance between the surface S2 and the surface S3 along the optical axis 12. Further, the interval, refractive index and Abbe number of any lens listed in the column of “Object description” show values in a horizontal row aligned with the position of that lens, so that related descriptions are omitted for sake of brevity.

TABLE 1

| | | Radius of | | | Abbe |
|---|---|---|---|---|---|
| | Sur- | curva- | Inter- | Refractive | num- |
| Object description | face | ture(mm) | val (mm) | index (nd) | ber (Vd) |
| Lens L1 | S1 | 9.872 | 0.609 | 1.772 | 50 |
| (meniscus/glass) | | | | | |
| | S2 | 2.760 | 1.758 | | |
| Lens L4 | S3 | 16.819 | 0.500 | 1.535 | 56 |
| (aspheric/plastic) | | | | | |
| | S4 | 1.495 | 1.698 | | |
| Lens L5 | S5 | 6.498 | 1.734 | 1.639 | 23 |
| (aspheric/plastic) | | | | | |
| | S6 | −6.106 | 0.200 | | |
| Stop 14 | S7 | Infinity | 0.253 | | |
| Lens L2 | S8 | −31.659 | 1.327 | 1.621 | 64 |
| (aspheric/glass) | | | | | |
| | S9 | −1.845 | 0.200 | | |
| Lens L6 | S10 | −5.796 | 0.500 | 1.639 | 23 |
| (aspheric/plastic) | | | | | |
| Lens L3 | S11 | 1.698 | 1.811 | 1.535 | 56 |
| (aspheric/plastic) | | | | | |
| | S12 | −2.517 | 1.134 | | |
| Optical filter 16 | S13 | Infinity | 0.300 | (Table 3) | (Table 3) |
| (gradient | | | | | |
| refractive index) | | | | | |
| | S14 | Infinity | 1.037 | | |
| Cover plate18 | S15 | Infinity | 0.300 | 1.517 | 64 |
| | S16 | Infinity | 0.045 | | |
| Image plane22 | S17 | Infinity | 0 | | |

An aspheric lens indicates at least one of its front lens surface and rear lens surface has a radius of curvature that varies along a center axis to correct abbreviations. In the following design examples of the invention, each aspheric surface satisfies the following equation:

$$Z = \frac{{cr}^{2}}{1 + \sqrt{1 - ( 1 + k ) {c}^{2} {r}^{2}}} + {Ar}^{4} + {Br}^{6} + {Cr}^{8} + {Dr}^{10} + {Er}^{12} + {Fr}^{14} + {Gr}^{16} + … ,$$

where Z denotes a sag of an aspheric surface along the optical axis 12, c denotes a reciprocal of a radius of an osculating sphere, K denotes a conic constant, r denotes a height of the aspheric surface measured in a direction perpendicular to the optical axis 12, and parameters A-G are 4th, 6th, 8th, 10th, 12th, 14th and 16th order aspheric coefficients. Note the data provided below are not used for limiting the invention, and those skilled in the art may suitably modify parameters or settings of the following embodiment with reference of the invention without departing from the scope or spirit of the invention.

TABLE 2

| | S3 | S4 | S5 | S6 | S8 | S9 | S10 | S11 | S12 |
|---|---|---|---|---|---|---|---|---|---|
| K | 15.05715 | −0.08822 | 13.67271 | −98.7786 | 0 | −6.51229 | −99 | −3.54932 | −1.90236 |
| A | 4.12E−02 | 3.68E−02 | 1.26E−02 | −8.01E−03 | 2.16E−02 | −5.10E−02 | −4.58E−03 | 7.44E−02 | −3.95E−03 |
| B | −1.96E−02 | 6.20E−02 | 5.25E−03 | 5.50E−02 | −3.29E−03 | 1.29E−02 | −9.40E−03 | −3.14E−02 | −5.44E−03 |
| C | 6.18E−03 | −1.30E−01 | 2.86E−04 | −3.69E−02 | −6.04E−03 | −8.23E−03 | −5.50E−04 | 8.48E−03 | 3.64E−03 |
| D | −1.39E−03 | 1.15E−01 | −1.71E−05 | 1.67E−02 | 2.80E−03 | 1.72E−03 | 8.77E−04 | −1.15E−03 | −1.24E−03 |
| E | 2.29E−04 | −5.09E−02 | 0 | 1.87E−16 | 0 | 0 | −1.64E−14 | 1.28E−13 | 1.78E−04 |
| F | −2.64E−05 | 1.09E−02 | 0 | 0 | 0 | 0 | 0 | 0 | 0 |
| G | 1.53E−06 | −9.61E−04 | 0 | 0 | 0 | 0 | 0 | 0 | 0 |

In at least some embodiments of the invention, the direction of variation in the inhomogeneous material of a lens with a gradient refractive index can include both radial and axial directions. The refractive index calculation formula is:

$$n ( r , z ) = n 00 + C 01 \times z + C 02 \times {z}^{2} + C 10 \times {r}^{2} + C 20 \times {r}^{4} + C 30 \times {r}^{6} ,$$

where n is the refractive index, r is the radial distance from the lens center, z is the axial distance along the optical axis, n00 is the base refractive index, C01, C02, C10, C20 and C30 are coefficients representing the axial gradient of the refractive index, and n(r, z) is the refractive index at a point with a prescribed radial distance r and axial distance z. Table 3 below details the design parameters of the lens with gradient refractive index (optical filter 16) of the lens 10a. Table 3 shows the values of the base refractive index and the gradient coefficients for light of different wavelengths. The horizontal fields, C-line, D-line, and F-line, represent wavelengths of 656.27 nm (hydrogen C-line), 587.56 nm (helium D-line) and 486.12 nm (hydrogen F-line), respectively. The vertical fields are n00 for the base refractive index and C01, C02, C10, C20 and C30 are the coefficients representing the axial gradient of the refractive index.

TABLE 3

| | C-line | D-line | F-line |
|---|---|---|---|
| | (656.27 nm) | (587.56 nm) | (486.12 nm) |
| n00 | 1.426 | 1.429 | 1.433 |
| C01 | −5.409E−02 | −5.511E−02 | −5.605E−02 |
| C02 | 2.167E−07 | 2.207E−07 | 2.245E−07 |
| C10 | 1.475E−02 | 1.503E−02 | 1.529E−02 |
| C20 | 4.026E−08 | 4.102E−08 | 4.172E−08 |
| C30 | 8.268E−12 | 8.424E−12 | 8.567E−12 |

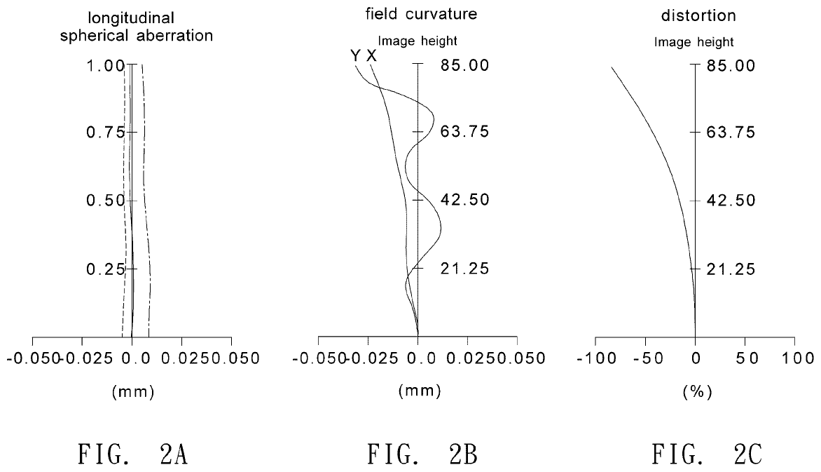

FIG. 2A, FIG. 2B, and FIG. 2C show optical simulation results of the imaging lens 10a according to this embodiment. FIG. 2A, FIG. 2B, and FIG. 2C respectively show the longitudinal spherical aberration, field curvature aberration, and distortion aberration curves of the imaging lens 10a measured at wavelengths of 486 nm, 546 nm, and 656 nm. Because the graphs shown in FIG. 2A, FIG. 2B, and FIG. 2C are all within the standard range, it can be verified that the imaging lens 10a can provide good optical imaging quality.

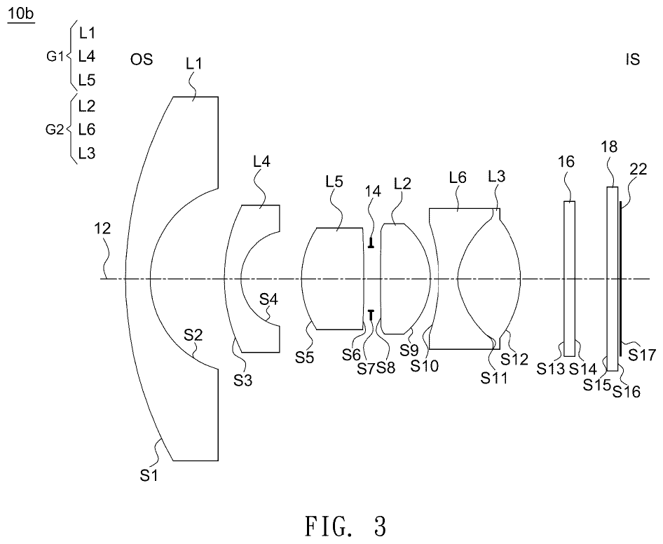

FIG. 3 is a schematic diagram of an imaging lens according to a second embodiment of the invention. The imaging lens 10b of this embodiment includes, arranged in order from the object side OS to the image side IS, the lens L1, the lens L4, and the lens L5 (forming the first lens group with a negative refractive power), the lens L2, the lens L6, and the lens L3 (forming the second lens group with a positive refractive power), an optical filter 16, a cover plate 18, and an aperture stop 14 disposed between the lens L5 and the lens L2. In this embodiment, the lens L4 is an inhomogeneous material lens with a gradient refractive index. The refractive powers of the lens L1, the lens L4, the lens L5, the lens L2, the lens L6, and the lens L3 in this embodiment are negative, negative, positive, positive, negative, and positive, respectively. The lens L1 is a glass spherical lens, the lens L4 is an inhomogeneous material lens with a gradient refractive index and is an aspheric lens, the lens L2 is a glass-molded aspheric lens, and the lens L5, the lens L6, and the lens L3 are plastic aspheric lenses, but this is not limiting. The lens L6 and the lens L3 are bonded to form a compound lens, such as a cemented doublet, but this is not limiting. Bonding the lens L6 and the lens L3 can correct chromatic aberrations and tolerate higher manufacturing tolerances, thereby increasing yield. The above structure combining glass and plastic materials and using a gradient refractive index lens can further eliminate chromatic and spherical aberrations, thus improving image quality.

In this embodiment of the imaging lens 10b, the effective focal length EFL is 1.2 mm, the F-number (F #) is 1.8, the diagonal field of view DFOV is 170 degrees, the total track length TTL is 14.2 mm, the total lens length LT is 11.68 mm, the maximum image height is 2.03 mm, the lens L4 is the specific lens with a gradient refractive index, and the ratio D/T of the lens L4 is 9.19.

The detailed optical data of the imaging lens 10b of the second embodiment is shown in Table 4 below.

TABLE 4

| | | Radius of | | | Abbe |
|---|---|---|---|---|---|
| | Sur- | curva- | Inter- | Refractive | num- |
| Object description | face | ture(mm) | val (mm) | index (nd) | ber (Vd) |
| Lens L1 | S1 | 11.892 | 0.595 | 1.772 | 50 |
| (meniscus/glass) | | | | | |
| | S2 | 2.828 | 1.997 | | |
| Lens L4 | S3 | 13.002 | 0.468 | (Table 6) | (Table 6) |
| (aspheric/gradient | | | | | |
| refractive index) | | | | | |
| | S4 | 1.458 | 1.691 | | |
| Lens L5 | S5 | 6.512 | 1.595 | 1.639 | 23 |
| (aspheric/plastic) | | | | | |
| | S6 | −6.093 | 0.200 | | |
| Stop 14 | S7 | Infinity | 0.257 | | |
| Lens L2 | S8 | −30.861 | 1.341 | 1.621 | 64 |
| (aspheric/glass) | | | | | |
| | S9 | −1.842 | 0.200 | | |
| Lens L6 | S10 | −5.762 | 0.501 | 1.639 | 23 |
| (aspheric/plastic) | | | | | |
| Lens L3 | S11 | 1.705 | 1.708 | 1.535 | 56 |
| (aspheric/plastic) | | | | | |
| | S12 | −2.504 | 1.134 | | |
| Optical filter 16 | S13 | Infinity | 0.300 | 1.517 | 64 |
| | S14 | Infinity | 1.031 | | |
| Cover plate18 | S15 | Infinity | 0.300 | 1.517 | 64 |
| | S16 | Infinity | 0.045 | | |
| Image plane22 | S17 | Infinity | 0 | | |

The conic constants and aspheric coefficients of each aspheric surface of the imaging lens 10b are shown in Table 5.

TABLE 5

| | S3 | S4 | S5 | S6 | S8 | S9 | S10 | S11 | S12 |
|---|---|---|---|---|---|---|---|---|---|
| K | 29.361932 | −0.09205 | 13.63001 | −98.8063 | 0 | −6.51451 | −98.8838 | −3.46957 | −1.89383 |
| A | 4.18E−02 | 3.47E−02 | 1.25E−02 | −7.99E−03 | 2.16E−02 | −5.10E−02 | −4.61E−03 | 7.50E−02 | −3.99E−03 |
| B | −1.96E−02 | 6.18E−02 | 5.23E−03 | 5.51E−02 | −3.33E−03 | 1.29E−02 | −9.43E−03 | −3.12E−02 | −5.45E−03 |
| C | 6.19E−03 | −1.30E−01 | 2.82E−04 | −3.69E−02 | −6.08E−03 | −8.21E−03 | −5.68E−04 | 8.54E−03 | 3.63E−03 |
| D | −1.39E−03 | 1.15E−01 | −1.80E−05 | 1.67E−02 | 2.76E−03 | 1.73E−03 | 8.65E−04 | −1.13E−03 | −1.24E−03 |
| E | 2.29E−04 | −5.09E−02 | 0 | 1.87E−16 | 0 | 0 | −1.64E−14 | 1.28E−13 | 1.78E−04 |
| F | −2.64E−05 | 1.09E−02 | 0 | 0 | 0 | 0 | 0 | 0 | 0 |
| G | 1.53E−06 | −9.61E−04 | 0 | 0 | 0 | 0 | 0 | 0 | 0 |

The design parameters of the lens with gradient refractive index (the lens L4) of the imaging lens 10b are shown in Table 6.

TABLE 6

| | C-line | d-line | F-line |
|---|---|---|---|
| | (656.27 nm) | (587.56 nm) | (486.13 nm) |
| n00 | 1.426 | 1.429 | 1.433 |
| C01 | −5.409E−02 | −5.511E−02 | −5.605E−02 |
| C02 | 2.167E−07 | 2.207E−07 | 2.245E−07 |
| C10 | 1.475E−02 | 1.503E−02 | 1.529E−02 |
| C20 | 4.026E−08 | 4.102E−08 | 4.172E−08 |
| C30 | 8.268E−12 | 8.424E−12 | 8.567E−12 |

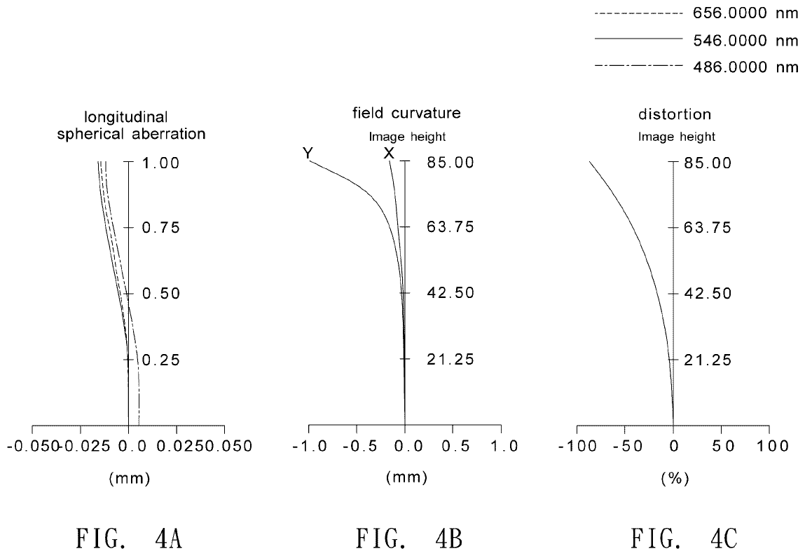

FIG. 4A, FIG. 4B, and FIG. 4C show optical simulation results of the imaging lens 10b according to this embodiment. FIG. 4A, FIG. 4B, and FIG. 4C respectively show the longitudinal spherical aberration, field curvature aberration, and distortion aberration curves of the imaging lens 10b measured at wavelengths of 486 nm, 546 nm, and 656 nm. Because the graphs shown in FIG. 4A, FIG. 4B, and FIG. 4C are all within the standard range, it can be verified that the imaging lens 10b can provide good optical imaging quality.

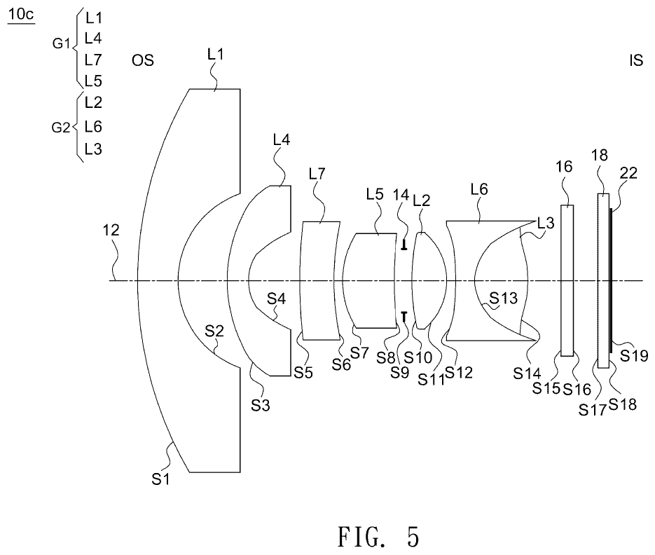

FIG. 5 is a schematic diagram of an imaging lens according to a third embodiment of the invention. The imaging lens 10c of this embodiment includes, arranged in order from the object side OS to the image side IS, the lens L1, the lens L4, the lens L7, the lens L5 (forming the first lens group G1 with a negative refractive power), the lens L2, the lens L6, and the lens L3 (forming the second lens group G2 with a positive refractive power), an optical filter 16, a cover plate 18, and an aperture stop 14 disposed between the lens L5 and the lens L2. In this embodiment, the optical filter 16 uses inhomogeneous materials to create a gradient refractive index, and the optical filter 16 is a flat lens having a refractive power and a smooth surface without microstructures. The refractive powers of the lens L1, the lens L4, the lens L7, the lens L5, the lens L2, the lens L6, and the lens L3 in this embodiment are negative, negative, negative, positive, positive, negative, and positive, respectively. The lens L1 and the lens L7 are glass spherical lenses, the lens L2 is a glass-molded aspheric lens, and the lens L4, the lens L5, the lens L6, and the lens L3 are plastic aspheric lenses, but this is not limiting. The lens L6 and the lens L3 are bonded to form a compound lens, such as a cemented doublet, but this is not limiting. Bonding the lens L6 and the lens L3 can correct chromatic aberrations and tolerate higher manufacturing tolerances, thereby increasing yield. The above structure combining glass and plastic materials and using a gradient refractive index lens can further eliminate chromatic and spherical aberrations, thus improving image quality.

In this embodiment of the imaging lens 10c, the effective focal length EFL is 1.0 mm, the F-number F # is 1.8, the diagonal field of view DFOV is 170 degrees, the total track length TTL is 13.0 mm, the total lens length LT is 11.02 mm, the maximum image height is 1.98 mm, the optical filter 16 is the specific lens with a gradient refractive index, and the ratio D/T of the optical filter 16 is 11.34.

TABLE 7

| | | Radius of | | | Abbe |
|---|---|---|---|---|---|
| | Sur- | curva- | Inter- | Refractive | num- |
| Object description | face | ture(mm) | val (mm) | index (nd) | ber (Vd) |
| Lens L1 | S1 | 11.256 | 1.006 | 1.772 | 50 |
| (meniscus/glass) | | | | | |
| | S2 | 2.573 | 1.273 | | |
| Lens L4 | S3 | 17.871 | 0.540 | 1.535 | 56 |
| (aspheric/plastic) | | | | | |
| | S4 | 1.469 | 1.291 | | |
| Lens L7 | S5 | 16.697 | 0.896 | 1.772 | 50 |
| (meniscus/glass) | | | | | |
| | S6 | 8.845 | 0.200 | | |
| Lens L5 | S7 | 4.277 | 1.333 | 1.639 | 23 |
| (aspheric/plastic) | | | | | |
| | S8 | −9.357 | 0.200 | | |
| Stop 14 | S9 | Infinity | 0.217 | | |
| Lens L2 | S10 | 6.240 | 0.897 | 1.621 | 64 |
| (aspheric/glass) | | | | | |
| | S11 | −1.814 | 0.203 | | |
| Lens L6 | S12 | −6.311 | 0.500 | 1.639 | 23 |
| (aspheric/plastic) | | | | | |
| Lens L3 | S13 | 1.289 | 1.328 | 1.535 | 56 |
| (aspheric/plastic) | | | | | |
| | S14 | −2.894 | 0.838 | | |
| Optical filter 16 | S15 | Infinity | 0.300 | (Table 9) | (Table 9) |
| (gradient | | | | | |
| refractive index) | | | | | |
| | S16 | Infinity | 0.632 | | |
| Cover plate18 | S17 | Infinity | 0.300 | 1.517 | 64 |
| | S18 | Infinity | 0.045 | | |
| Image plane22 | S19 | Infinity | 0 | | |

The conic constants and aspheric coefficients for each aspheric surface of the imaging lens 10c are shown in Table 8.

TABLE 8

| | S3 | S4 | S7 | S8 | S10 | S11 | S12 | S13 | S14 |
|---|---|---|---|---|---|---|---|---|---|
| K | 33.704698 | −0.1617 | 5.323173 | −250.784 | 0 | −5.5038 | −94.7181 | −2.55432 | −11.0183 |
| A | 7.75E−02 | 9.29E−02 | 2.48E−02 | 5.00E−02 | 3.06E−02 | −7.10E−02 | −2.29E−02 | 8.15E−02 | −2.51E−02 |
| B | −2.89E−02 | 7.10E−02 | 8.11E−03 | 4.85E−02 | −2.69E−02 | 8.26E−03 | 4.79E−03 | −1.02E−02 | 2.25E−02 |
| C | 7.31E−03 | −1.40E−01 | −9.94E−04 | −2.65E−02 | 4.33E−03 | −6.89E−03 | 3.68E−03 | 2.62E−02 | −3.62E−03 |
| D | −1.45E−03 | 1.15E−01 | 5.35E−04 | 3.32E−02 | 1.00E−03 | 9.83E−04 | −2.11E−03 | −6.61E−03 | −3.42E−05 |
| E | 2.29E−04 | −5.09E−02 | 0 | 1.87E−16 | 0 | 0 | −1.64E−14 | 1.28E−13 | 1.78E−04 |
| F | −2.64E−05 | 1.09E−02 | 0 | 0 | 0 | 0 | 0 | 0 | 0 |
| G | 1.53E−06 | −9.61E−04 | 0 | 0 | 0 | 0 | 0 | 0 | 0 |

The design parameters of the lens with gradient refractive index (optical filter 16) of the imaging lens 10c are shown in Table 9.

TABLE 9

| | C-line | d-line | F-line |
|---|---|---|---|
| | (656.27 nm) | (587.56 nm) | (486.13 nm) |
| n00 | 1.426 | 1.429 | 1.433 |
| C01 | −5.409E−02 | −5.511E−02 | −5.605E−02 |
| C02 | 2.167E−07 | 2.207E−07 | 2.245E−07 |
| C10 | 1.475E−02 | 1.503E−02 | 1.529E−02 |
| C20 | 4.026E−08 | 4.102E−08 | 4.172E−08 |
| C30 | 8.268E−12 | 8.424E−12 | 8.567E−12 |

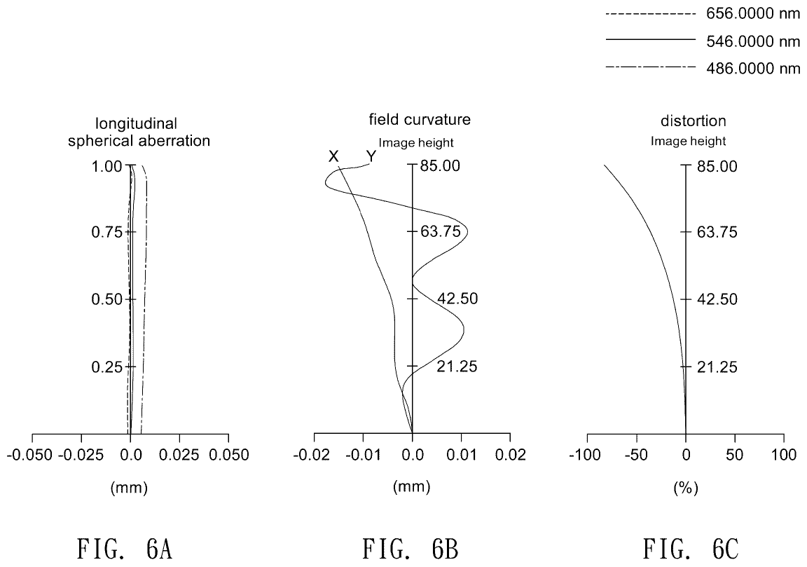

FIG. 6A, FIG. 6B, and FIG. 6C show optical simulation results of the imaging lens 10c according to this embodiment. FIG. 6A, FIG. 6B, and FIG. 6C respectively show the longitudinal spherical aberration, field curvature aberration, and distortion aberration curves of the imaging lens 10c measured at wavelengths of 486 nm, 546 nm, and 656 nm. Because the graphs shown in FIG. 6A, FIG. 6B, and FIG. 6C are all within the standard range, it can be verified that the imaging lens 10c can provide good optical imaging quality.

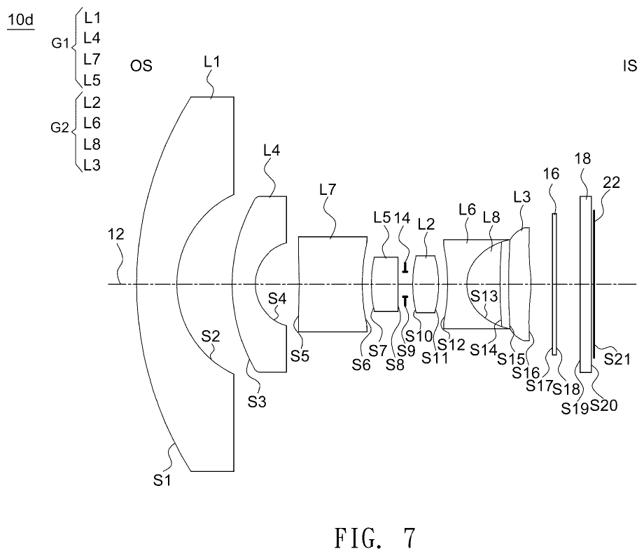

FIG. 7 is a schematic diagram of an imaging lens according to a fourth embodiment of the invention. The imaging lens 10d of this embodiment includes, arranged in order from the object side OS to the image side IS, the lens L1, the lens L4, the lens L7, the lens L5 (forming the first lens group G1 with a negative refractive power), the lens L2, the lens L6, the lens L8, the lens L3 (forming the second lens group G2 with a positive refractive power), an optical filter 16, a cover plate 18, and an aperture stop 14 disposed between the lens L5 and the lens L2. In this embodiment, the optical filter 16 uses inhomogeneous materials to create a gradient refractive index, and the optical filter 16 is a flat lens having a refractive power and a smooth surface without microstructures. The refractive powers of the lens L1, the lens L4, the lens L7, the lens L5, the lens L2, the lens L6, the lens L8, and the lens L3 in this embodiment are negative, negative, negative, positive, positive, negative, positive, and positive, respectively. The lens L1 and the lens L7 are glass spherical lenses, the lens L2 is a glass-molded aspheric lens, and the lens L4, the lens L5, the lens L6, the lens L8, and the lens L3 are plastic aspheric lenses, but this is not limiting. The lens L6 and the lens L8 are bonded to form a compound lens, such as a cemented doublet, but this is not limiting. Bonding the lens L6 and the lens L8 can correct chromatic aberrations and tolerate higher manufacturing tolerances, thereby increasing yield. The above structure combining glass and plastic materials and using a gradient refractive index lens can further eliminate chromatic and spherical aberrations, thus improving image quality.

In this embodiment of the imaging lens 10d, the effective focal length EFL is 0.4 mm, the F-number F # is 1.8, the diagonal field of view DFOV is 170 degrees, the total track length TTL is 13.0 mm, the total lens length LT is 11.24 mm, the maximum image height is 2.01 mm, the optical filter 16 is the specific lens with a gradient refractive index, and the ratio D/T of the optical filter 16 is 31.21.

TABLE 10

| | | Radius of | | | Abbe |
|---|---|---|---|---|---|
| | Sur- | curva- | Inter- | Refractive | num- |
| Object description | face | ture(mm) | val (mm) | index (nd) | ber (Vd) |
| Lens L1 | S1 | 10.258 | 0.993 | 1.772 | 50 |
| (meniscus/glass) | | | | | |
| | S2 | 2.816 | 1.489 | | |
| Lens L4 | S3 | 13.528 | 0.592 | 1.535 | 56 |
| (aspheric/plastic) | | | | | |
| | S4 | 1.306 | 1.169 | | |
| Lens L7 | S5 | 36.166 | 1.718 | 1.772 | 50 |
| (meniscus/glass) | | | | | |
| | S6 | 6.539 | 0.200 | | |
| Lens L5 | S7 | 3.389 | 0.701 | 1.639 | 23 |
| (aspheric/plastic) | | | | | |
| | S8 | −8.061 | 0.204 | | |
| Stop 14 | S9 | Infinity | 0.200 | | |
| Lens L2 | S10 | 3.647 | 0.692 | 1.621 | 64 |
| (aspheric/glass) | | | | | |
| | S11 | −1.971 | 0.200 | | |
| Lens L6 | S12 | −8.611 | 0.500 | 1.639 | 23 |
| (aspheric/plastic) | | | | | |
| Lens L8 | S13 | 0.935 | 0.903 | 1.535 | 56 |
| (aspheric/plastic) | | | | | |
| | S14 | 0.388 | 0.226 | | |
| Lens L3 | S15 | 0.359 | 0.576 | 1.639 | 23 |
| (aspheric/plastic) | | | | | |
| | S16 | −7.323 | 0.584 | | |
| Optical filter 16 | S17 | Infinity | 0.100 | (Table 12) | (Table 12) |
| (gradient | | | | | |
| refractive index) | | | | | |
| | S18 | Infinity | 0.615 | | |
| Cover plate18 | S19 | Infinity | 0.300 | 1.517 | 64 |
| | S20 | Infinity | 0.045 | | |
| Image plane22 | S21 | Infinity | 0 | | |

The conic constants and aspheric coefficients for each aspheric surface of the imaging lens 10d are shown in Table 11.

TABLE 11

| | S3 | S4 | S7 | S8 | S10 | S11 |
|---|---|---|---|---|---|---|
| K | 4.1614917 | −0.36146 | 4.189562 | −183.22 | 0 | −5.60256 |
| A | 6.50E−02 | 1.06E−01 | 3.60E−02 | 5.13E−02 | 1.95E−02 | −6.20E−02 |
| B | −2.77E−02 | 6.65E−02 | 1.68E−02 | 7.31E−02 | −3.47E−02 | 2.67E−03 |
| C | 7.38E−03 | −1.34E−01 | −1.95E−03 | −4.85E−02 | −1.93E−04 | −1.31E−02 |
| D | −1.46E−03 | 1.18E−01 | 9.82E−03 | 4.65E−02 | −4.74E−04 | −1.60E−03 |
| E | 2.29E−04 | −5.09E−02 | 0 | 1.87E−16 | 0 | 0 |
| F | −2.64E−05 | 1.09E−02 | 0 | 0 | 0 | 0 |
| G | 1.53E−06 | −9.61E−04 | 0 | 0 | 0 | 0 |

| | S12 | S13 | S14 | S15 | S16 |
|---|---|---|---|---|---|
| K | −94.13485 | −2.45163 | −9.003E+18 | −4.2E+18 | −83.2796 |
| A | −1.64E−02 | 1.65E−01 | 1.73E−02 | −8.25E−04 | −1.38E−02 |
| B | 6.33E−03 | −2.63E−02 | 1.41E−02 | 5.49E−03 | 1.57E−02 |
| C | −4.11E−03 | 3.96E−02 | 2.66E−03 | −1.05E−03 | −4.26E−03 |
| D | −1.66E−03 | 8.45E−03 | 6.45E−04 | 4.09E−03 | 1.64E−03 |
| E | −1.64E−14 | 1.28E−13 | 0 | 0 | 1.78E−04 |
| F | 0 | 0 | 0 | 0 | 0 |
| G | 0 | 0 | 0 | 0 | 0 |

The design parameters of the lens with gradient refractive index (optical filter 16) of the lens 10d are shown in Table 12.

TABLE 12

| | C-line | d-line | F-line |
|---|---|---|---|
| | (656.27 nm) | (587.56 nm) | (486.13 nm) |
| n00 | 1.426 | 1.429 | 1.433 |
| C01 | −5.409E−02 | −5.511E−02 | −5.605E−02 |
| C02 | 2.167E−07 | 2.207E−07 | 2.245E−07 |
| C10 | 1.475E−02 | 1.503E−02 | 1.529E−02 |
| C20 | 4.026E−08 | 4.102E−08 | 4.172E−08 |
| C30 | 8.268E−12 | 8.424E−12 | 8.567E−12 |

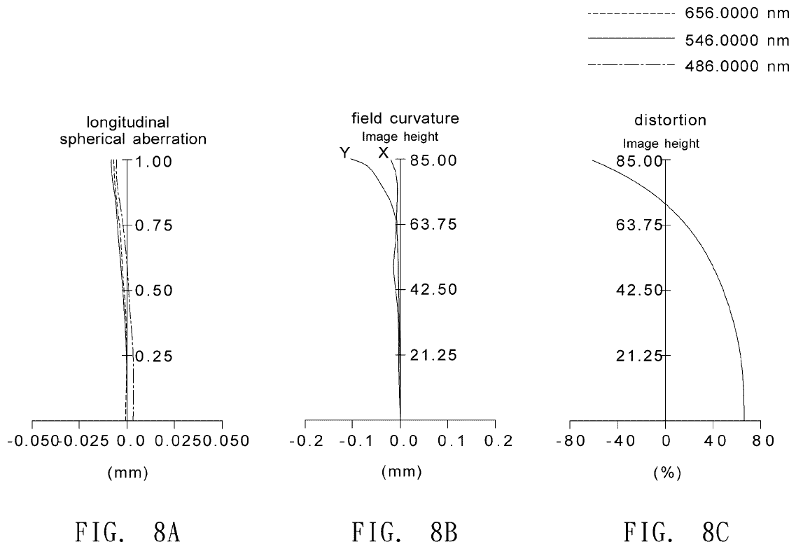

FIG. 8A, FIG. 8B, and FIG. 8C show optical simulation results of the imaging lens 10d according to this embodiment. FIG. 8A, FIG. 8B, and FIG. 8C respectively show the longitudinal spherical aberration, field curvature aberration, and distortion aberration curves of the imaging lens 10d measured at wavelengths of 486 nm, 546 nm, and 656 nm. Because the graphs shown in FIG. 8A, FIG. 8B, and FIG. 8C are all within the standard range, it can be verified that the imaging lens 10d can provide good optical imaging quality.

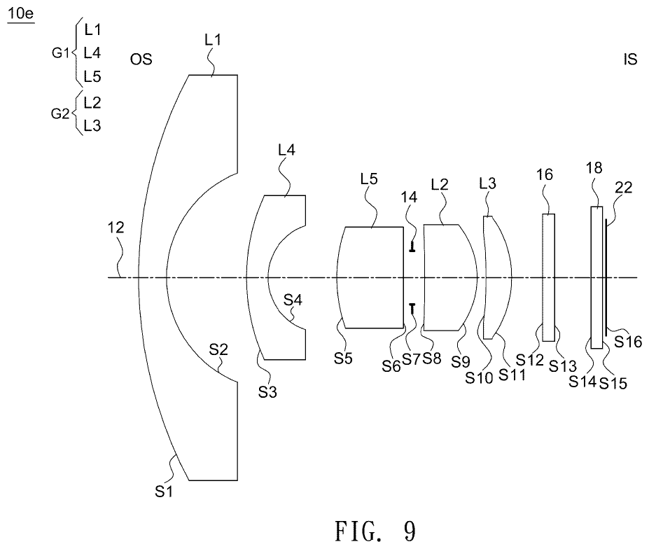

FIG. 9 is a schematic diagram of an imaging lens according to a fifth embodiment of the invention. In this embodiment, the imaging lens 10e includes, arranged in order from the object side OS to the image side IS, the lens L1, the lens L4, the lens L5 (forming the first lens group G1 with a negative refractive power), the lens L2, the lens L3 (forming the second lens group G2 with a positive refractive power), an optical filter 16, a cover plate 18, and an aperture stop 14 disposed between the lens L5 and the lens L2. In this embodiment, the lens L4 is an inhomogeneous material lens with a gradient refractive index. In other embodiments, the inhomogeneous material lens with a gradient refractive index can be any one of the lens L5, the lens L2 and the lens L3. The refractive powers of the lens L1, the lens L4, the lens L5, the lens L2, and the lens L3 are negative, negative, positive, positive, and positive, respectively. The lens L1 is a glass spherical lens, the lens L4 is an inhomogeneous material lens with a gradient refractive index and is an aspheric lens, the lens L2 is a glass-molded aspheric lens, and the lenses L5 and L3 are plastic aspheric lenses, but this is not limiting. The above structure combining glass and plastic materials and using a gradient refractive index lens can further eliminate chromatic and spherical aberrations, thus improving image quality.

In this embodiment of the imaging lens 10e, the effective focal length EFL is 0.8 mm, the F-number F # is 1.8, the diagonal field of view DFOV is 170 degrees, the total track length TTL is 12.2 mm, the total lens length LT is 8.85 mm, the maximum image height is 1.33 mm, the lens L4 is the specific lens with a gradient refractive index, and the ratio D/T of the lens L4 is 8.86.

TABLE 13

| | | Radius of | | | Abbe |
|---|---|---|---|---|---|
| | Sur- | curva- | Inter- | Refractive | num- |
| Object description | face | ture(mm) | val (mm) | index (nd) | ber (Vd) |
| Lens L1 | S1 | 11.892 | 0.595 | 1.743 | 49 |
| (meniscus/glass) | | | | | |
| | S2 | 2.828 | 1.997 | | |
| Lens L4 | S3 | 13.002 | 0.468 | (Table 15) | (Table 15) |
| (aspheric/gradient | | | | | |
| refractive index) | | | | | |
| | S4 | 1.458 | 1.691 | | |
| Lens L5 | S5 | 6.512 | 1.595 | 1.639 | 23 |
| (aspheric/plastic) | | | | | |
| | S6 | −6.093 | 0.200 | | |
| Stop 14 | S7 | Infinity | 0.257 | | |
| Lens L2 | S8 | −30.861 | 1.341 | 1.621 | 64 |
| (aspheric/glass) | | | | | |
| | S9 | −1.842 | 0.200 | | |
| Lens L3 | S10 | −5.762 | 0.609 | 1.639 | 23 |
| (aspheric/plastic) | | | | | |
| | S11 | −2.504 | 0.740 | | |
| Optical filter 16 | S12 | Infinity | 0.300 | 1.517 | 64 |
| | S13 | Infinity | 0.856 | | |
| Cover plate18 | S14 | Infinity | 0.300 | 1.517 | 64 |
| | S15 | Infinity | 0.045 | | |
| Image plane22 | S16 | Infinity | 0 | | |

The conic coefficients and aspheric coefficients of each aspheric surface of the imaging lens 10e are shown in Table 14.

TABLE 14

| | S3 | S4 | S5 | S6 | S8 | S9 | S10 | S11 |
|---|---|---|---|---|---|---|---|---|
| K | 29.361932 | −0.09205 | 13.63001 | −98.8063 | 0 | −98.8838 | −1.89383 | −1.89383 |
| A | 4.18E−02 | 3.47E−02 | 1.25E−02 | −7.99E−03 | 2.16E−02 | −4.61E−03 | −3.99E−03 | −3.99E−03 |
| B | −1.96E−02 | 6.18E−02 | 5.23E−03 | 5.51E−02 | −3.33E−03 | −9.43E−03 | −5.45E−03 | −5.45E−03 |
| C | 6.19E−03 | −1.30E−01 | 2.82E−04 | −3.69E−02 | −6.08E−03 | −5.68E−04 | 3.63E−03 | 3.63E−03 |
| D | −1.39E−03 | 1.15E−01 | −1.80E−05 | 1.67E−02 | 2.76E−03 | 8.65E−04 | −1.24E−03 | −1.24E−03 |
| E | 2.29E−04 | −5.09E−02 | 0 | 1.87E−16 | 0 | −1.64E−14 | 1.78E−04 | 1.78E−04 |
| F | −2.64E−05 | 1.09E−02 | 0 | 0 | 0 | 0 | 0 | 0 |
| G | 1.53E−06 | −9.61E−04 | 0 | 0 | 0 | 0 | 0 | 0 |

The design parameters of the lens with gradient refractive index (lens L4) of the imaging lens 10e are shown in Table 15.

TABLE 15

| | C-line | d-line | F-line |
|---|---|---|---|
| | (656.27 nm) | (587.56 nm) | (486.13 nm) |
| n00 | 1.426 | 1.429 | 1.433 |
| C01 | −5.409E−02 | −5.511E−02 | −5.605E−02 |
| C02 | 2.167E−07 | 2.207E−07 | 2.245E−07 |
| C10 | 1.475E−02 | 1.503E−02 | 1.529E−02 |
| C20 | 4.026E−08 | 4.102E−08 | 4.172E−08 |
| C30 | 8.268E−12 | 8.424E−12 | 8.567E−12 |

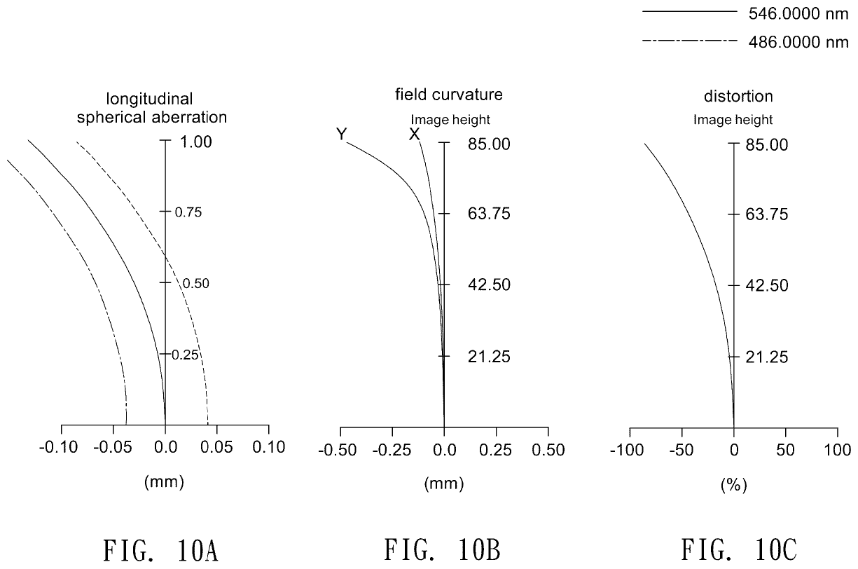

FIG. 10A, FIG. 10B, and FIG. 10C show optical simulation results of the imaging lens 10e according to this embodiment. FIG. 10A, FIG. 10B, and FIG. 10C respectively show the longitudinal spherical aberration, field curvature aberration, and distortion aberration curves of the imaging lens 10e measured at wavelengths of 486 nm, 546 nm, and 656 nm. Because the graphs shown in FIG. 10A, FIG. 10B, and FIG. 10C are all within the standard range, it can be verified that the imaging lens 10e can provide good optical imaging quality.

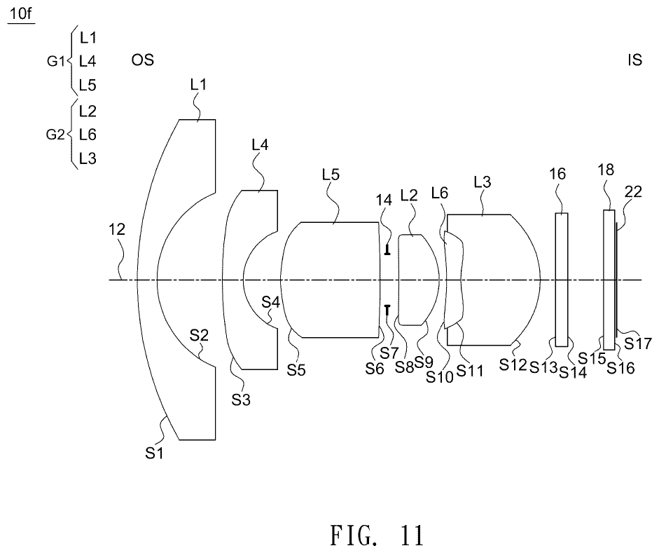

FIG. 11 is a schematic diagram of an imaging lens according to a sixth embodiment of the invention. In this embodiment, the imaging lens 10f includes, arranged in order from the object side OS to the image side IS, the lens L1, the lens L4, the lens L5 (forming the negative refractive power first lens group G1), the lens L2, the lens L6 and the lens L3 (forming the positive refractive power second lens group G2), an optical filter 16, a cover plate 18, and an aperture stop 14 disposed between the lens L5 and the lens L2. In this embodiment, the lens L6 is an inhomogeneous material lens with a gradient refractive index and is an aspheric lens. The refractive powers of the lens L1, the lens L4, the lens L5, the lens L2, the lens L6, and the lens L3 are negative, negative, positive, positive, negative, and positive, respectively. The lens L1 is a glass spherical lens, the lens L6 is an inhomogeneous material lens with a gradient refractive index and is an aspheric lens, the lens L2 is a glass-molded aspheric lens, and the lens L4, the lens L5, and the lens L3 are plastic aspheric lenses, but this is not limiting. The lens L6 and the lens L3 are bonded to form a compound lens, such as a cemented doublet, but this is not limiting. Bonding the lens L6 and the lens L3 can correct chromatic aberrations and tolerate higher manufacturing tolerances, thereby increasing yield. Additionally, the above structure combining glass and plastic materials and using a gradient refractive index lens can further eliminate chromatic and spherical aberrations, thus improving image quality. In this embodiment of the imaging lens 10f, the effective focal length EFL is 0.9 mm, the F-number F # is 1.8, the diagonal field of view DFOV is 170 degrees, the total track length TTL is 12.2 mm, the total lens length LT is 10.23 mm, the maximum image height is 1.75 mm, the lens L6 is the specific lens with a gradient refractive index, and the ratio D/T of the lens L6 is 5.77.

TABLE 16

| | | Radius of | | | Abbe |
|---|---|---|---|---|---|
| | Sur- | curva- | Inter- | Refractive | num- |
| Object description | face | ture(mm) | val (mm) | index (nd) | ber (Vd) |
| Lens L1 | S1 | 9.636 | 0.500 | 1.772 | 50 |
| (meniscus/glass) | | | | | |
| | S2 | 2.692 | 1.653 | | |
| Lens L4 | S3 | 51.568 | 0.500 | 1.535 | 56 |
| (aspheric/plastic) | | | | | |
| | S4 | 1.496 | 0.995 | | |
| Lens L5 | S5 | 5.956 | 2.488 | 1.639 | 23 |
| (aspheric/plastic) | | | | | |
| | S6 | −6.129 | 0.204 | | |
| Stop 14 | S7 | Infinity | 0.271 | | |
| Lens L2 | S8 | −13.085 | 1.025 | 1.621 | 64 |
| (aspheric/glass) | | | | | |
| | S9 | −1.711 | 0.200 | | |
| Lens L6 | S10 | −5.851 | 0.357 | (Table 18) | (Table 18) |
| (aspheric/gradient | | | | | |
| refractive index) | | | | | |
| Lens L3 | S11 | 2.838 | 2.034 | 1.535 | 56 |
| (aspheric/plastic) | | | | | |
| | S12 | −2.224 | 0.360 | | |
| Optical filter 16 | S13 | Infinity | 0.300 | 1.517 | 64 |
| | S14 | Infinity | 0.921 | | |
| Cover plate18 | S15 | Infinity | 0.300 | 1.517 | 64 |
| | S16 | Infinity | 0.045 | | |
| Image plane22 | S17 | Infinity | 0 | | |

The conic coefficients and aspheric coefficients of each aspheric surface of the imaging lens 10f are shown in Table 17.

TABLE 17

| | S3 | S4 | S5 | S6 | S8 | S9 | S10 | S11 | S12 |
|---|---|---|---|---|---|---|---|---|---|
| K | 98.74453 | −0.06299 | 14.0909 | −97.9931 | 0 | −5.71019 | −99.0023 | −20.7118 | −1.6212 |
| A | 3.43E−02 | 3.19E−02 | 1.28E−02 | −1.61E−02 | 1.94E−02 | −5.90E−02 | −4.32E−03 | 1.07E−02 | −6.29E−03 |
| B | −1.58E−02 | 6.08E−02 | −1.17E−03 | 4.51E−02 | −3.36E−03 | 2.18E−02 | −3.52E−03 | −5.87E−02 | −5.42E−03 |
| C | 5.54E−03 | −1.29E−01 | 3.95E−03 | −3.06E−02 | −2.63E−03 | −1.28E−02 | 9.79E−04 | −7.60E−03 | 3.54E−03 |
| D | −1.34E−03 | 1.13E−01 | −1.22E−03 | 1.28E−02 | 7.46E−03 | 2.42E−03 | 2.89E−03 | −9.75E−03 | −1.22E−03 |
| E | 2.29E−04 | −5.09E−02 | 0 | 1.87E−16 | 0 | 0 | −1.64E−14 | 1.28E−13 | 1.78E−04 |
| F | −2.64E−05 | 1.09E−02 | 0 | 0 | 0 | 0 | 0 | 0 | 0 |
| G | 1.53E−06 | −9.61E−04 | 0 | 0 | 0 | 0 | 0 | 0 | 0 |

The design parameters of the lens with gradient refractive index (lens L6) of the imaging lens 10f are shown in Table 18.

TABLE 18

| | C-line | d-line | F-line |
|---|---|---|---|
| | (656.27 nm) | (587.56 nm) | (486.13 nm) |
| n00 | 1.426 | 1.429 | 1.433 |
| C01 | −5.409E−02 | −5.511E−02 | −5.605E−02 |
| C02 | 2.167E−07 | 2.207E−07 | 2.245E−07 |
| C10 | 1.475E−02 | 1.503E−02 | 1.529E−02 |
| C20 | 4.026E−08 | 4.102E−08 | 4.172E−08 |
| C30 | 8.268E−12 | 8.424E−12 | 8.567E−12 |

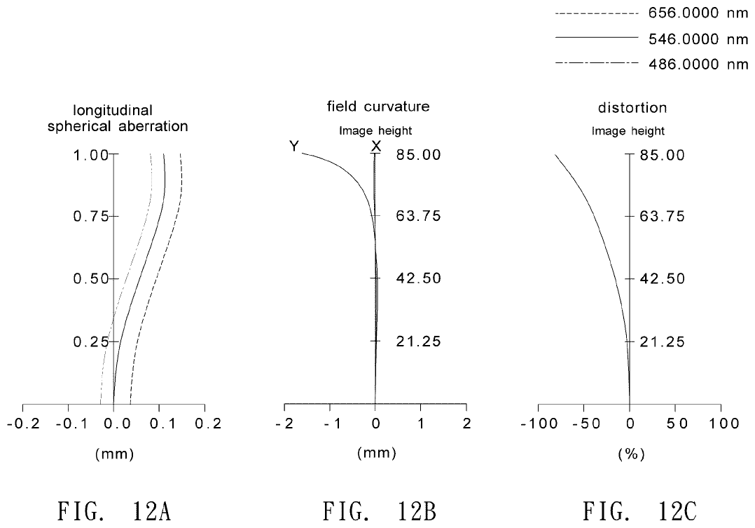

FIG. 12A, FIG. 12B, and FIG. 12C show optical simulation results of the imaging lens 10f according to this embodiment. FIG. 12A, FIG. 12B, and FIG. 12C respectively show the longitudinal spherical aberration, field curvature aberration, and distortion aberration curves of the imaging lens 10f measured at wavelengths of 486 nm, 546 nm, and 656 nm. Because the graphs shown in FIG. 12A, FIG. 12B, and FIG. 12C are all within the standard range, it can be verified that the imaging lens 10f can provide good optical imaging quality.

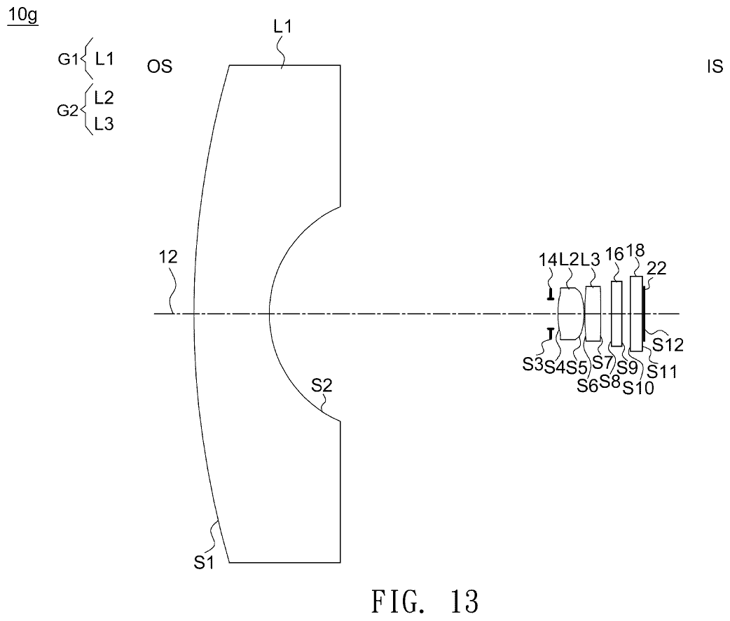

FIG. 13 is a schematic diagram of an imaging lens according to a seventh embodiment of the invention. In this embodiment, the imaging lens 10g includes, arranged in order from the object side OS to the image side IS, the lens L1 (forming the first lens group G1 with a negative refractive power), the lens L2, the lens L3 (forming the second lens group G2 with a positive refractive power), an optical filter 16, a cover plate 18, and an aperture stop 14 disposed between the lens L1 and the lens L2. In this embodiment, the lens L3 is an inhomogeneous material lens with a gradient refractive index. The refractive powers of the lens L1, the lens L2, and the lens L3 are negative, positive, and positive, respectively. The lens L1 is a glass spherical lens, the lens L3 is an inhomogeneous material lens with a gradient refractive index and is an aspheric lens, and the lens L2 is a glass-molded aspheric lens, but this is not limiting. The above structure combining glass and plastic materials and using a gradient refractive index lens can further eliminate chromatic and spherical aberrations, thus improving image quality.

In this embodiment of the imaging lens 10g, the effective focal length EFL is 0.4 mm, the F-number F # is 1.8, the diagonal field of view DFOV is 170 degrees, the total track length TTL is 8.1 mm, the total lens length LT is 7.03 mm, the maximum image height is 0.79 mm, the lens L3 is the specific lens with a gradient refractive index, and the ratio D/T of the lens L3 is 2.33.

TABLE 19

| | | Radius of | | | Abbe |
|---|---|---|---|---|---|
| | Sur- | curva- | Inter- | Refractive | num- |
| Object description | face | ture(mm) | val (mm) | index (nd) | ber (Vd) |
| Lens L1 | S1 | 18.336 | 1.334 | 1.815 | 44 |
| (meniscus/glass) | | | | | |
| | S2 | 2.268 | 5.095 | | |
| Stop 14 | S3 | Infinity | 0.100 | | |
| Lens L2 | S4 | 1.121 | 0.473 | 1.733 | 49 |
| (aspheric/glass) | | | | | |
| | S5 | −2.782 | 0.029 | | |
| Lens | S6 | 4.672 | 0.289 | (Table 21) | (Table 21) |
| L3(aspheric/ | | | | | |
| gradient | | | | | |
| refractive index) | | | | | |
| | S7 | −1.133 | 0.189 | | |
| Optical filter 16 | S8 | Infinity | 0.200 | 1.621 | 64 |
| | S9 | Infinity | 0.140 | | |
| Cover plate18 | S10 | Infinity | 0.200 | 1.621 | 64 |
| | S11 | Infinity | 0.045 | | |
| Image plane22 | S12 | Infinity | 0 | | |

The conic coefficients and aspheric coefficients of each aspheric surface of the imaging lens 10g are shown in Table 20.

TABLE 20

| | S4 | S5 | S6 | S7 |
|---|---|---|---|---|
| K | −2.483968 | 33.09613 | 61.52552 | −88.846 |
| A | −7.07E−02 | −2.88E−01 | 3.65E−01 | 1.35E+00 |
| B | −4.47E−01 | −1.92E+00 | 1.42E+00 | 3.98E+00 |
| C | −3.94E+00 | −6.82E+00 | −1.82E+01 | 5.99E−08 |
| D | −8.20E+00 | −6.40E−06 | 3.49E−07 | 7.88E−09 |

The design parameters of the lens with gradient refractive index (lens L3) of the imaging lens 10g are shown in Table 21.

TABLE 21

| | C-line | d-line | F-line |
|---|---|---|---|
| | (656.27 nm) | (587.56 nm) | (486.13 nm) |
| n00 | 1.426 | 1.429 | 1.433 |
| C01 | −5.409E−02 | −5.509E−02 | −5.605E−02 |
| C02 | 2.167E−07 | 2.206E−07 | 2.245E−07 |
| C10 | 1.475E−02 | 1.502E−02 | 1.529E−02 |
| C20 | 4.026E−08 | 4.100E−08 | 4.172E−08 |
| C30 | 8.268E−12 | 8.420E−12 | 8.567E−12 |

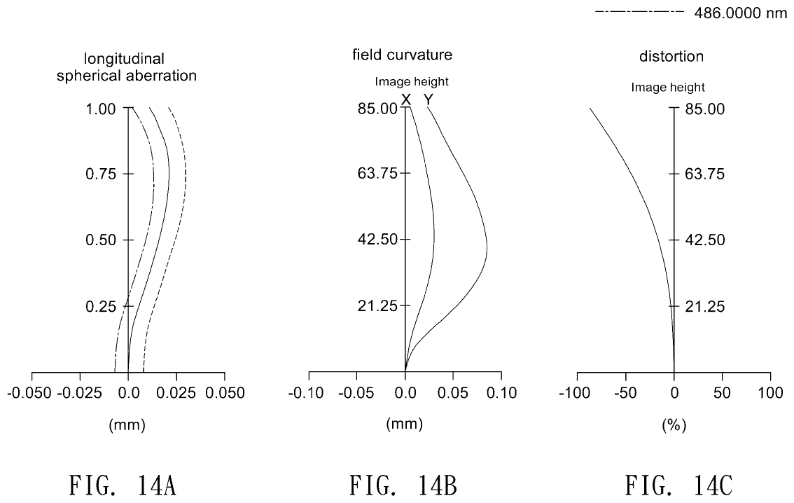

FIG. 14A, FIG. 14B, and FIG. 14C show optical simulation results of the imaging lens 10g according to this embodiment. FIG. 14A, FIG. 14B, and FIG. 14C respectively show the longitudinal spherical aberration, field curvature aberration, and distortion aberration curves of the imaging lens 10g measured at wavelengths of 486 nm, 546 nm, and 656 nm. Because the graphs shown in FIG. 14A, FIG. 14B, and FIG. 14C are all within the standard range, it can be verified that the imaging lens 10g can provide good optical imaging quality.

According to the above embodiments, by adhering to the aforementioned component characteristics and configuration conditions, the imaging lens can provide good chromatic aberration correction while meeting the wide viewing angle requirements. This is achieved without needing to change the thickness of the optical filter, allowing for high-quality imaging in both visible and infrared light. Furthermore, by appropriately combining glass and plastic lenses with spherical and aspherical surfaces, the imaging lens can withstand high temperatures and temperature fluctuations in the operating environment, thereby reducing manufacturing costs while maintaining image quality. Moreover, the imaging lens includes at least one gradient-index singlet lens/inhomogeneous-material singlet lens, which can provide chromatic aberration correction similar to that of cemented lenses. This configuration can reduce the number of cemented lenses used, thereby decreasing the lens size, number of lenses, or overall length while meeting the requirements for chromatic aberration correction and use of both infrared light and visible light imaging.

Though the embodiments of the invention have been presented for purposes of illustration and description, they are not intended to be exhaustive or to limit the invention. Accordingly, many modifications and variations without departing from the spirit of the invention or essential characteristics thereof will be apparent to practitioners skilled in this art. It is intended that the scope of the invention be defined by the claims appended hereto and their equivalents in which all terms are meant in their broadest reasonable sense unless otherwise indicated.

What is claimed is:

1. An imaging lens, comprising:
a first lens, a second lens, and a third lens arranged in order from an object side to an image side of the imaging lens, wherein the first lens has a negative refractive power, the imaging lens includes no more than nine lenses with refractive powers, and one of the no more than nine lenses is a gradient-index (GRIN) lens; and
an aperture stop disposed between two outermost lenses with refractive powers at opposite ends of the imaging lens;
wherein the gradient-index lens satisfies a condition of 1<D/T<32, where D is a maximum outer diameter of the gradient-index lens, and T is a thickness of the gradient-index lens measured along an optical axis of the imaging lens.

2. The imaging lens as claimed in claim 1, wherein the gradient-index lens satisfies a condition of 5<D/T<13, and the gradient-index lens has a refractive index gradient that varies in both radial and axial directions.

3. The imaging lens as claimed in claim 1, wherein the second lens is a glass-molded aspheric lens, and the third lens is the gradient-index lens.

4. The imaging lens as claimed in claim 1, further comprising a fourth lens and a fifth lens, wherein the fourth lens and the fifth lens are disposed between the first lens and the second lens.

5. The imaging lens as claimed in claim 4, wherein the fifth lens, the second lens, and the third lens are aspheric lenses, and one of the fourth lens, the fifth lens, the second lens, and the third lens is the gradient-index lens.

6. The imaging lens as claimed in claim 4, further comprising a sixth lens disposed between the second lens and the third lens.

7. The imaging lens as claimed in claim 6, wherein the fourth lens or the sixth lens is the gradient-index lens.

8. The imaging lens as claimed in claim 6, wherein the fourth lens, the fifth lens, the second lens, the sixth lens, and the third lens are aspheric lenses.

9. The imaging lens as claimed in claim 6, further comprising a seventh lens disposed between the fourth lens and the fifth lens.

10. The imaging lens as claimed in claim 9, further comprising an eighth lens disposed between the sixth lens and the third lens, wherein the first lens, the fourth lens, the seventh lens and the fifth lens form a first lens group with a negative refractive power, and the second lens, the sixth lens, the eighth lens and the third lens form a second lens group with a positive refractive power.

11. An imaging lens, comprising:
a first lens, a second lens, and a third lens arranged in order from an object side to an image side of the imaging lens, wherein the first lens has a negative refractive power, the imaging lens includes no more than nine lenses with refractive powers, one of the no more than nine lenses is an inhomogeneous material lens, and two opposite surfaces of the inhomogeneous material lens along the optical axis of the imaging lens have different refractive indices; and
an aperture stop disposed between two outermost lenses with refractive powers at opposite ends of the imaging lens;
wherein the inhomogeneous material lens satisfies a condition of 1<D/T<32, where D is a maximum outer diameter of the inhomogeneous material lens, and T is a thickness of the inhomogeneous material lens measured along an optical axis of the imaging lens.

12. The imaging lens as claimed in claim 11, wherein the inhomogeneous material lens satisfies a condition of 5<D/T<13.

13. The imaging lens as claimed in claim 11, wherein the imaging lens includes at least one aspheric lens, and the aperture stop is disposed between the first lens and the second lens.

14. The imaging lens as claimed in claim 11, further comprising a fourth lens and a fifth lens, wherein the fourth lens and the fifth lens are disposed between the first lens and the second lens.

15. The imaging lens as claimed in claim 14, wherein the fifth lens, the second lens, and the third lens are aspheric lenses, and one of the fourth lens, the fifth lens, the second lens, and the third lens is the inhomogeneous material lens.

16. The imaging lens as claimed in claim 14, further comprising a sixth lens disposed between the second lens and the third lens.

17. The imaging lens as claimed in claim 16, wherein the fourth lens or the sixth lens is the inhomogeneous material lens.

18. The imaging lens as claimed in claim 16, further comprising a seventh lens disposed between the fourth lens and the fifth lens.

19. The imaging lens as claimed in claim 18, further comprising an eighth lens disposed between the sixth lens and the third lens, wherein the first lens, the fourth lens, the seventh lens and the fifth lens form a first lens group with a negative refractive power, and the second lens, the sixth lens, the eighth lens and the third lens form a second lens group with a positive refractive power.

20. An imaging lens, comprising:
a first lens, a second lens, and a third lens arranged in order from an object side to an image side of the imaging lens, wherein the first lens has a negative refractive power, the imaging lens includes no more than nine lenses with refractive powers, and one of the no more than nine lenses is a flat lens with a refractive power having a smooth surface without microstructures; and
an aperture stop disposed between two outermost lenses with refractive powers at opposite ends of the imaging lens.

21. The imaging lens as claimed in claim 20, wherein D is a maximum outer diameter of the flat lens, T is a thickness of the flat lens measured along an optical axis of the imaging lens, and the flat lens satisfies a condition of 1<D/T<32.

22. The imaging lens as claimed in claim 20, wherein the flat lens is an optical filter.
